(19) United States
(12) Patent Application Publication
(10) Pub. No.: US 2007/0086191 A1
(43) Pub. Date: Apr. 19, 2007

(54) Optical member, method of manufacturing the optical member, and display device having the optical member

(75) Inventors: Jin-Sung Choi, Chungcheongnam-do (KR); Jung-Wook Paek, Gyeonggi-do (KR); Jheen-Hyeok Park, Gyeonggi-do (KR); Byung-Yun Joo, Gyeonggi-do (KR); Ju-Hwa Ha, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/525,472

(22) Filed: Sep. 21, 2006

(30) Foreign Application Priority Data
Sep. 21, 2005 (KR) 2005-87495

(51) Int. Cl. F21S 8/00

(52) U.S. Cl. 362/268

(57) ABSTRACT

An optical member that lends itself to be more cost-effectively manufactured than a conventional optical member is presented. A display device made with the optical member can be thinner than the conventional optical member. The optical member includes a light-incident face that receives light emitted from a lamp positioned at a side of the optical member, a light-exiting face that is in a plane perpendicular to the light-incident face, and a light reflecting face opposite to the light-exiting face. A light-concentrating pattern having a plurality of concentric circles is formed on the light-exiting face. The light-concentrating pattern may be the Fresnel lens pattern. A diffusing pattern for diffusing the light is formed on the light reflecting face. Since patterns are formed on the optical member, additional optical sheet such as a prism sheet, a reflective polarizing sheet, a diffusion sheet, etc., is unnecessary.

### CROSS-REFERENCE TO RELATED APPLICATION

This application claims priority, under 35 USC § 119, from Korean Patent Application No. 2005-87495 filed on Sep. 21, 2005, the contents of which are herein incorporated by reference in their entirety.

### BACKGROUND OF THE INVENTION

1. Field of the Invention

The present invention relates to an optical member usable in a display device, and more particularly to an optical member that is manufactured more cost-effectively than the conventional optical member.

2. Description of the Related Art

In general, a display device for displaying an image is used in information-processing apparatuses such as notebook computer, television, etc. Examples of display device include a cathode ray tube (CRT), a plasma display panel (PDP), liquid crystal display (LCD), etc. Of the different types of display devices, LCD device that displays images using liquid crystal (LC) molecules is becoming increasinly widely adopted.

An LCD device displays an image using liquid crystal molecules that have certain optical and electrical characteristics, such as anisotropic refractive index and anisotropic dielectric constant, among others. Hence, an LCD device has characteristics such as a thinness, light weight, low driving voltage and low power consumption compared to those of other display devices.

A typical LCD device includes a lower substrate, an upper substrate, a liquid crystal layer arranged between the lower and upper substrates, and an LCD panel for displaying an image using light transmissivity. Light transmissivity varies in accordance with arrangement alterations of liquid crystal molecules in the liquid crystal layer.

Further, since the LCD panel of the LCD device is a non-light-emitting device that is not capable of emitting light on its own, a backlight assembly for supplying light to the LCD panel is required in the LCD device.

Generally, backlight assembly is classified as either an edge illumination type backlight assembly or a direct illumination type backlight assembly. The edge illumination type backlight assembly includes a lamp positioned at a side of a transparent light-guiding plate. The edge illumination type backlight assembly irradiates the LCD panel using one face of the light-guiding plate that reflects the light. In contrast, the direct illumination type backlight assembly includes lamps positioned under the LCD panel, a reflection plate positioned under the lamps, and a diffusion plate positioned over the lamps. The direct illumination type backlight assembly reflects and diffuses the light emitted by the lamps using the reflection plate and the diffusion plate. Thus, the edge illumination type backlight assembly is mainly used for a small LCD device where device thinness is a priority. In contrast, the direct illumination type backlight assembly is mainly used for a large LCD device where high luminance is a priority.

To improve luminance uniformity and general luminance level, additional diffusion sheet, prism sheet, and/or reflective polarizing sheet, etc., may be used in the edge illumination type and the direct illumination type backlight assemblies. However, the additional sheets cause a cost increase for manufacturing the backlight assembly. It is desirable to improve luminance without the added cost of the extra sheets.

### SUMMARY OF THE INVENTION

The present invention provides an optical member that is manufactured with low cost by eliminating the optical sheet. The present invention also provides a method of manufacturing the above-mentioned optical member. The present invention also provides a display device having the above-mentioned optical member.

In one aspect, the present invention is an optical member that includes a light-incident face receiving light that is emitted by a lamp positioned by a side of the optical member, a light-exiting face extending in a plane that is perpendicular to the plane of the light-incident face, and a light reflecting face opposite to the light-exiting face. A light-concentrating pattern having a plurality of concentric circles is formed on the light-exiting face.

In another aspect, the present invention is an optical member that includes a diffusion plate and a lens sheet attached to the diffusion plate. The diffusion plate has a light-incident face receiving light that is emitted from a lamp and a light-exiting face opposite to the light-incident face. The lens sheet that has a lens array having a plurality of convex lenses making contact with the diffusion plate.

In yet another aspect, the present invention is a method of manufacturing an optical member. The method entails forming a coating film on a light-exiting face of a transparent resin plate. The coating film is patterned using a mold, which has grooves of a pattern that is the reverse of a light-concentrating pattern, to form the light-concentrating pattern having a plurality of concentric circles on the coating film. The concentric circles function as a prism. The ligt-concentrating pattern is hardened.

In yet another aspect, the present invention is a method of manufacturing an optical member. The method entails forming a lens sheet having an array of convex lenses on a light-exiting face of a diffusion plate, for allowing the convex lens to make contact with the light-exiting face. A light-concentrating pattern having a plurality of concentric circles is formed on a light-incident face of the diffusion plate opposite to the light-exiting face.

In yet another aspect, the present invention is a display device that includes a lamp, an optical member and a display panel. The optical member includes a light-incident face and a light reflecting face that are opposite each other and a light-exiting face in a plane that is perpendicular to the light-incident face and the light-reflecting face, the light-incident face receiving light from the lamp and having a light-concentrating pattern including a plurality of concentric circles. The display panel s for displaying an image is disposed on the light-exiting face of the optical member.

In yet another aspect, the present invention is a display device having lamps, arranged parallel to each other, an optical member positioned to receive the light from the lamps, and a display panel displaying an image and positioned on the optical member. The optical member includes a diffusion plate that has a light-incident face and a light-exiting face that are opposite each other and a lens sheet attached to the diffusion plate. The lens sheet has a lens array including a plurality of convex lenses that make contact with the diffusion plate.

The present invention allows extra components such as a prism sheet, a reflective polarizing sheet, a diffusion sheet, etc. to be eliminated from the optical member and the display device without compromising the display quality. Therefore, costs for manufacturing the optical member and the display device may be reduced.

### BRIEF DESCRIPTION OF THE DRAWINGS

The above and other features and advantages of the present invention will become more apparent by describing in detailed example embodiments thereof with reference to the accompanying drawings, in which:

FIG. 1 is a perspective view illustrating an optical member in accordance with an embodiment of the present invention;

FIG. 2 is an enlarged perspective illustrating the light-concentrating pattern in FIG. 1;

FIG. 3 is a cross-sectional view taken along the line I-I′ in FIG. 2;

FIG. 4 is a plan view illustrating a light reflecting face of the optical member in FIG. 1;

FIG. 5 is a perspective view illustrating an optical member in accordance with is another embodiment of the present invention;

FIG. 6 is a perspective view illustrating a convex sheet in FIG. 5;

FIG. 7 is a perspective view illustrating a light-incident face in FIG. 5;

FIGS. 8 to 11 are cross-sectional views illustrating a method of manufacturing an optical member in accordance with yet another embodiment of the present 20 invention;

FIGS. 12 to 18 are cross-sectional views illustrating a method of manufacturing an optical member in accordance with yet another embodiment of the present invention;

FIG. 19 is an exploded perspective view illustrating a display device in accordance with yet another embodiment of the present invention; and

FIG. 20 is an exploded perspective view illustrating a display device in accordance with yet another embodiment of the present invention.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

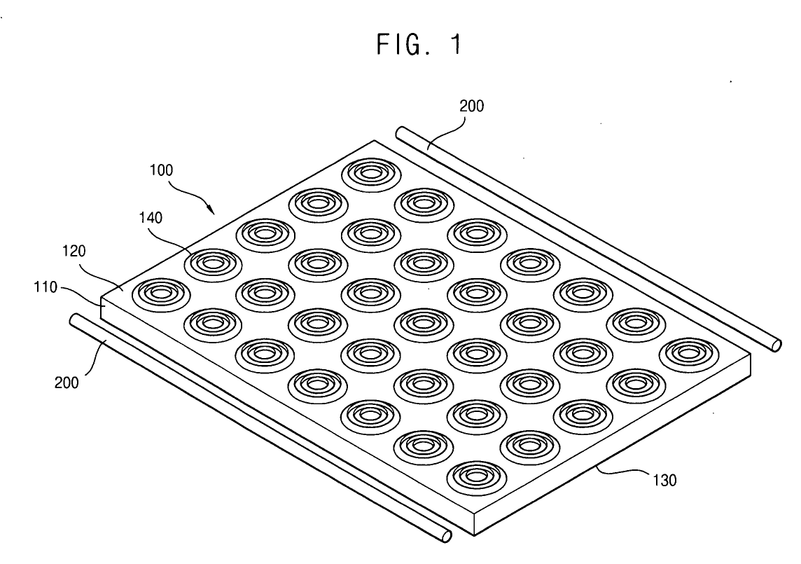

FIG. 1 is a perspective view illustrating an optical member in accordance with an embodiment of the present invention.

Referring to FIG. 1, an optical member 100 of this embodiment includes light-incident faces 110 positioned close to lamps 200, a light-exiting face 120 in a plane perpendicular to the planes of the light-incident faces 110, and a light reflecting face 130 in a plane that is parallel to the plane of the light-exiting face 120.

The lamps 200 are positioned near two surfaces of the optical member 100 that are parallel to each other. In an alternative embodiment, there may be only one lamp 200 near one surface of the optical member 100. In the embodiment shown, each of the lamps 200 is positioned next to one of the light-incident faces 110. However, this is not a limitation of the invention and multiple lamps 200 may be positioned next to one of the light-incident faces 110.

The optical member 100 guides light that is incident from the lamps 200 so that it travels in a desired path. The optical member 100 includes a transparent material for guiding the light. Examples of materials appropriate for the optical member 100 include polymethyl methacrylate (PMMA) and poly carbonate (PC) having a heat resistance superior to that of the PMMA.

A light-concentrating pattern 140 is formed on the light-exiting face 120 of the optical member 100 to concentrate the light. In this embodiment, the light-concentrating pattern 140 is regularly arranged on the light-exiting face 120. However, in other embodiments, the light-concentrating pattern 140 may be irregularly arranged on the light-exiting face 120 in accordance with positions of the lamps 200.

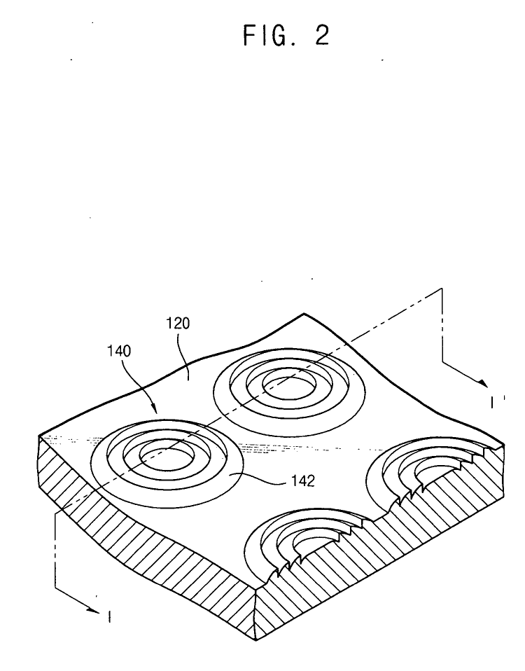

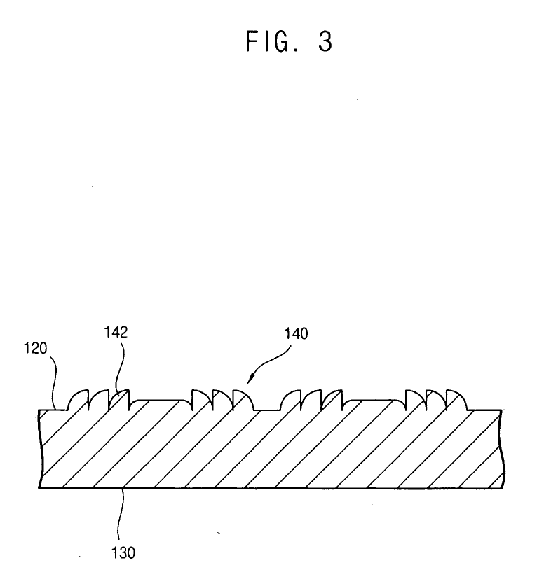

FIG. 2 is an enlarged perspective of the light-concentrating pattern in FIG. 1 and FIG. 3 is a cross-sectional view taken along a line I-I′ in FIG. 2.

Referring to FIGS. 2 and 3, the light-concentrating pattern 140 includes a plurality of concentric circles 142. Particularly, the light-concentrating pattern 140 has a Fresnel lens pattern. That is, the concentric circles function as a prism to provide the light-concentrating pattern 140 with an aberration and a thickness less than those of a convex lens.

The lights incident to the optical member 100 from every direction exit through the light-exiting face 120. Here, the lights are refracted in accordance with Snell's law in following Equation 1 and the exit through the light-exiting face 120.
n₁(sin θ₁)=n₂(sin θ₂) [Equation 1]

In Equation 1, “n₁” represents the index of refraction for the light-guiding plate and “n₂” indicates the index of refraction for air. Since the refractive index “n₁” of the light-guiding plate is higher than “n₂” of the air, “sin θ₂” is higher than “sine θ₁.” The angles θ₁ and θ₂ are measured with respect to an imaginary line normal to the surface of the light-guiding plate. Thus, the light exiting the light-concentrating pattern 140 inside the optical member 100 has a greater angle with respect to a normal vector than the light that travels through the light-guiding plate.

As a result of the refraction, the light that is emitted by the lamps 200 non-directionally in the optical member 100 is “concentrated” by the light-concentrating pattern 140 and exits through the light-exiting face 120.

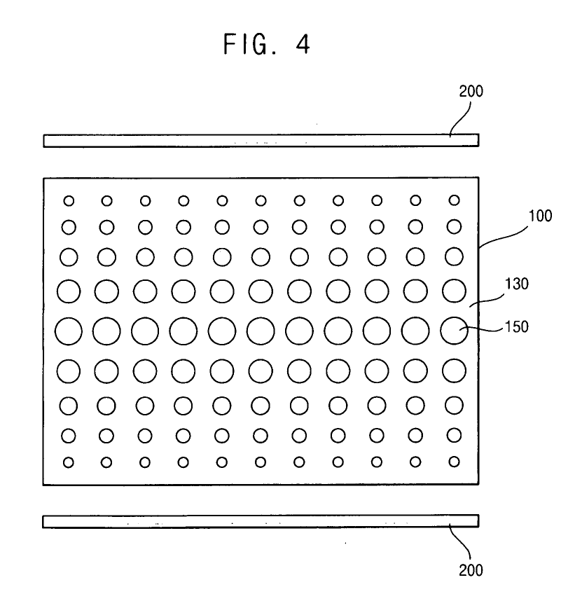

FIG. 4 is a plan view illustrating the light reflecting face of the optical member in FIG. 1.

Referring to FIGS. 1 and 4, a diffusing pattern 150 for diffusing the lights is formed on the light reflecting face 130 of the optical member 100. The diffusing pattern 150 diffuses and reflects the light emitted from the lamps 200 that is incident on the inside surface of the optical member 100. The diffused light is reflected and directed toward the light-exiting face 120 in various directions.

To improve the luminance uniformity of the light exiting from the light-exiting face 120, the diffusing pattern 150 is irregularly arranged in accordance with the positions of the lamps 200. Particularly, the diffusing pattern 150 is densely arranged in a region close to the lamps 200 and sparsely arranged in a region distant to the lamps 200.

In this embodiment, the diffusing pattern 150 includes a printed pattern having a circular shape formed by printing white ink on the light reflecting face 130. Alternatively, the diffusing pattern 150 may include a concave-convex pattern formed by a precision process

According to this embodiment, the light-concentrating pattern 140 is formed on the light-exiting face 120 of the optical member 100. Thus, an additional optical sheet such as a prism sheet, a reflective polarizing film, etc., may be omitted in the optical member 100.

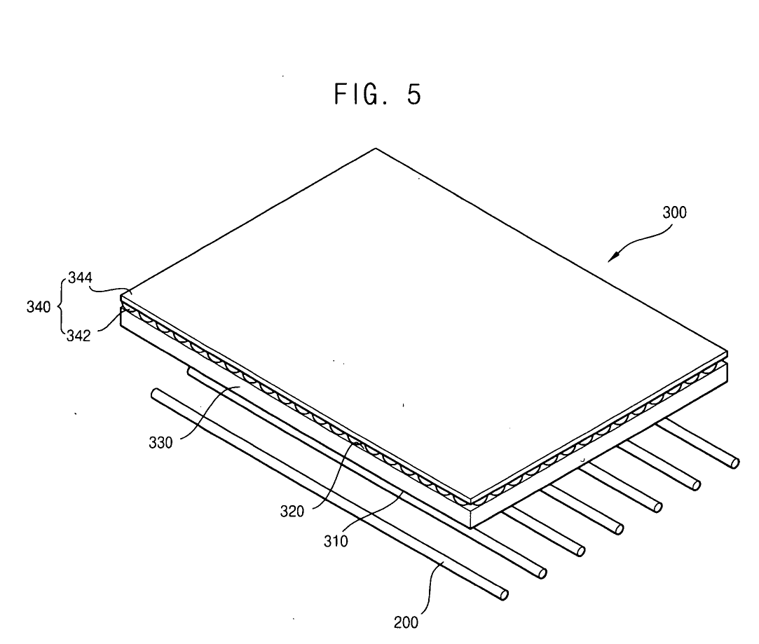

FIG. 5 is a perspective view illustrating an optical member in accordance with another embodiment of the present invention.

Referring to FIG. 5, an optical member 300 includes a diffusion plate 330 and a lens sheet 340 placed over the diffusion plate 330.

The diffusion plate 330 includes a light-incident face 310 that receives the light emitted by lamps that are arranged under the diffusion plate 330. A light-exiting face 320 is in a plane parallel to the light-incident face 310.

The diffusion plate 330 diffuses the light emitted from the lamps 200 to improve the luminance uniformity. The diffusion plate 330 is a rectangular plate having a predetermined thickness. Further, the diffusion plate 330 is spaced apart from the lamps 200. The diffusion plate 330 may include polymethyl methacrylate (PMMA). In addition, a diffusing agent for diffusing the lights may be provided in the diffusion plate 330.

The lamps 20 are arranged under the optical member 300. The lamps 200 are arranged in a plane that is substantially parallel to the optical member 300, and in the lamps are positioned parallel to each other.

The lens sheet 340 for concentrating the lights is formed on the light-exiting face 320 of the diffusion plate 330. The lens sheet 340 includes a base film 344 and a lens array formed on the base film 344. The lens array includes a plurality of convex lenses 342. The convex lenses 342 are regularly arranged on the base film 344. Alternatively, the convex lenses 342 may be irregularly arranged on the base film 344 in accordance with the positions of the lamps 200. An “array of convex lenses,” as used herein, is intended to include a lens array where some or all of the lenses are convex lenses.

The lens sheet 340 is attached to the diffusion plate 330 such that the convex lenses 343 contacts the light-exiting face 320 of the diffusion plate 330.

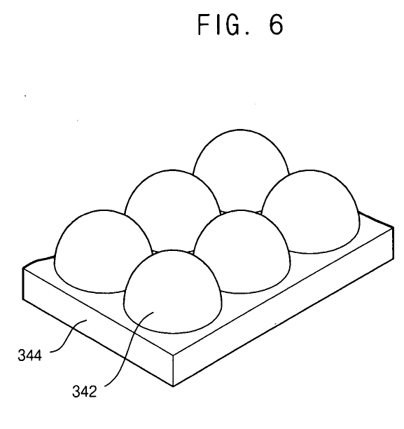

FIG. 6 is a perspective view illustrating a convex sheet in FIG. 5.

Referring to FIG. 6, the convex lenses 342 are formed on the base film 344 and have a semi-elliptical shape. In this particular embodiment, each of the convex lenses 342 has a diameter of about 50 μm and a height of about 20 μm.

The lens array having the convex lenses 342 is formed on a first face of the base film 344. A second face of the base film 344 that is parallel to the first face is then attached to the diffusion plate 330 to complete the optical member 300 having the lens sheet 340.

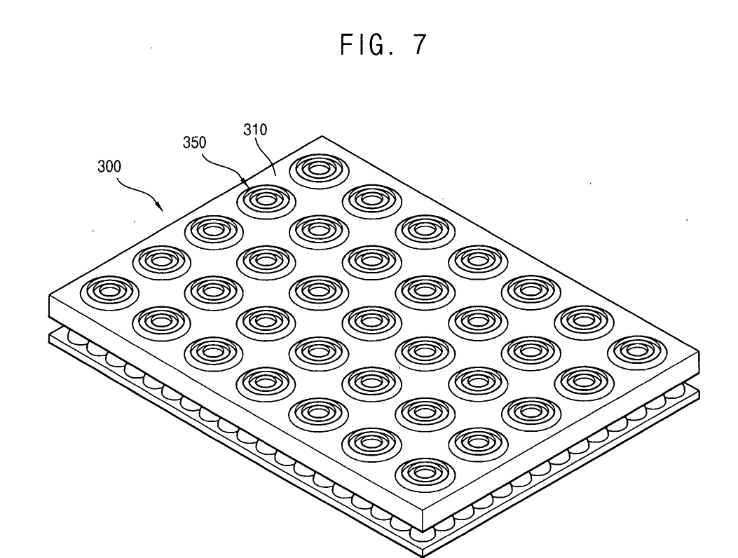

FIG. 7 is a perspective view illustrating the light-incident face in FIG. 5.

Referring to FIG. 7, a light-concentrating pattern 350 for concentrating the light is formed on the light-incident face 310 of the optical member 300. The light-concentrating pattern 350 is regularly arranged on the light-incident face 310. However, this is not a limitation of the invention and the light-concentrating pattern 350 may be irregularly arranged on the light-incident face 310 in accordance with the positions of the lamps 200.

The light-concentrating pattern 350 includes a plurality of concentric circles, similarly to the light-concentrating pattern 140 of FIG. 1. Particularly, the light-concentrating pattern 350 has a Fresnel lens pattern. That is, the concentric circles function as a prism to provide the light-concentrating pattern 140 with an aberration and a thickness less than those of a convex lens.

In this example embodiment, the light-concentrating pattern 350 is directly formed on the light-incident face 310 of the optical member 300. Alternatively, a light-concentrating sheet having the light-concentrating pattern 350 may be attached to the light-incident face 310 of the optical member 300.

The light emitted from the lamps 200 is concentrated by the light-concentrating pattern 350 on the light-incident face 310 and the lens sheet 340 on the light-exiting face 320 before exiting through the base film 344 (in an upward direction with respect to FIG. 5).

According to this embodiment, the lens sheet 340 and the light-concentrating 25 pattern 350 are formed on the light-exiting face 320 and the light-incident face 310 of the optical member 100, respectively. Thus, any additional optical sheet such as a prism sheet, a reflective polarizing film, etc., may be eliminated in the optical member 300.

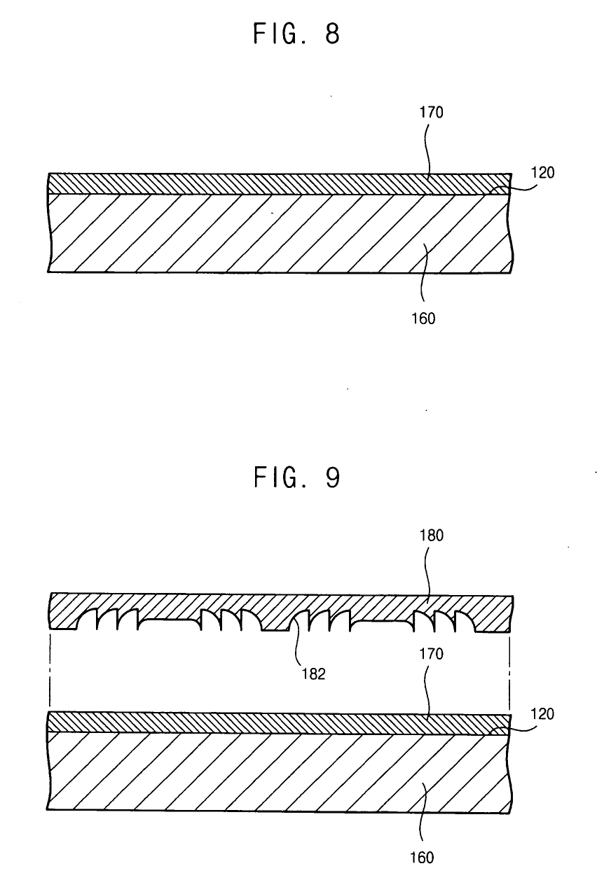

FIGS. 8 to 11 are cross-sectional views illustrating a method of manufacturing an optical member in accordance with yet another embodiment of the present invention.

Referring to FIG. 8, a coating film 170 is formed on the light-exiting face 120 of a transparent resin plate 160. The coating film 170 may have a uniform thickness. An example of the transparent resin plate 160 includes PMMA. Further, the coating film 170 includes an ultraviolet curable resin. Alternatively, the coating film 170 may include a thermosetting resin.

Referring to FIG. 9, a mold 180 having grooves that correspond to a light-concentrating pattern is placed over the transparent resin plate 160 on which the coating film 170 is formed.

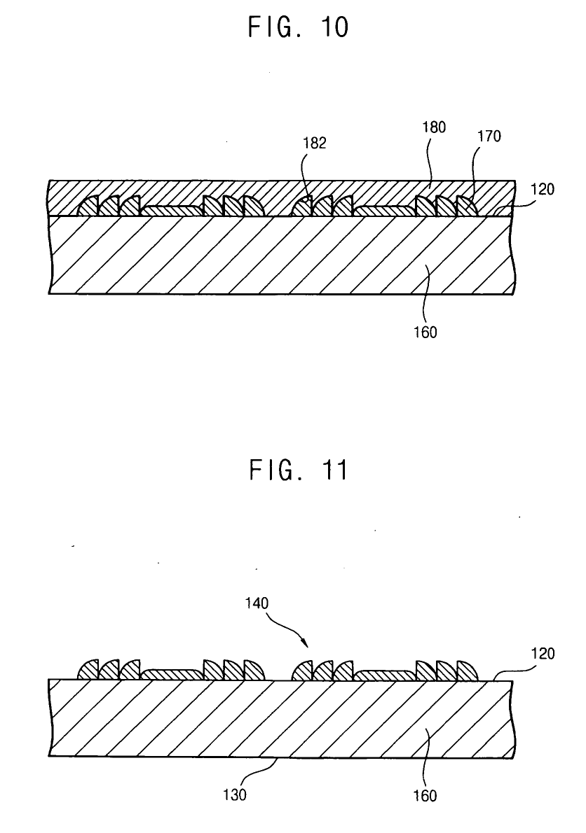

Referring to FIG. 10, the mold 170 is pressed into the coating film 170 to form the light-concentrating pattern 140 having a plurality of concentric circles. An ultraviolet ray or heat is then provided to the light-concentrating pattern 140 to harden the light-concentrating pattern 140.

Referring to FIG. 11, after hardening the light-concentrating pattern 140, the mold 180 is removed to complete the formation of the light-concentrating pattern 140 on the transparent resin plate 160. Here, the light-concentrating pattern 140 forms a Fresnel lens.

In addition, before or after forming the light-concentrating pattern 140, a diffusing pattern for diffusing lights is formed on a light reflecting face 130 of the transparent resin plate 160, which is on the opposite side of the light-exiting face 120. As described above, the diffusing pattern includes a printed pattern having a dotted shape formed by printing white ink. Alternatively, the diffusing pattern may include a concave-convex pattern formed by a precision process.

FIGS. 12 to 18 are cross-sectional views illustrating a method of manufacturing an optical member in accordance with yet another embodiment of the present invention. The method of manufacturing the optical member is divided into a process for forming a lens sheet and a process for forming the light-concentrating pattern. The lens sheet has an array of convex lenses on the light-exiting face of a diffusion plate for allowing the convex lenses to make contact with the light-exiting face. The light-concentrating pattern has a plurality of concentric circles on the light-incident face of the diffusion plate.

FIGS. 12 to 14 are cross-sectional views illustrating a process for forming the lens sheet having the lens array.

Referring to FIG. 12, a coating film 362 having a uniform thickness is formed on a base film 360. An example of the base film 360 includes polyethylene terephthalate (PET). The coating film 362 includes an ultraviolet curable resin or a thermosetting resin.

A first master mold 364 having grooves 366 that correspond to a lens pattern is then positioned over the coating film 362.

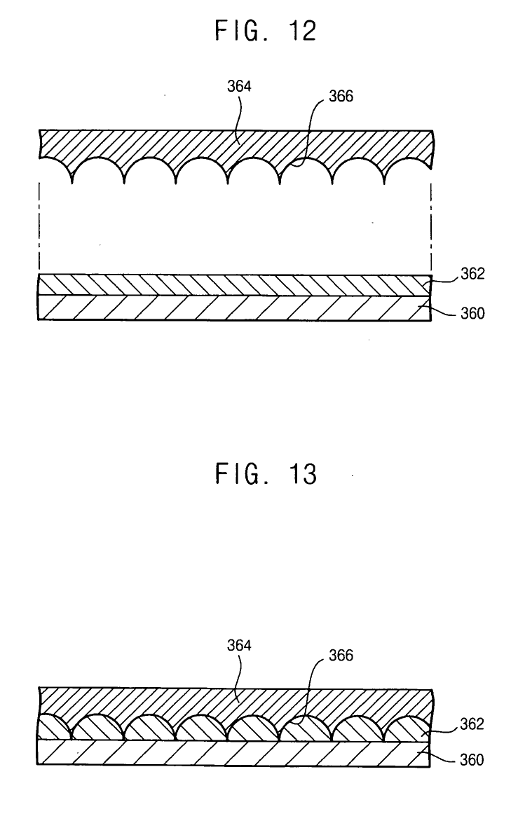

Referring to FIG. 13, the first master mold 364 is pressed into the coating film 362 to form the array of convex lenses. An ultraviolet ray or heat is provided to the lens array to harden (or cure) the lens array.

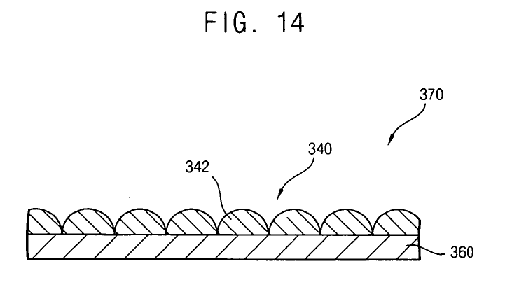

Referring to FIG. 14, after hardening the lens array, the first master mold 364 is removed, leaving the lens array having the convex lenses 342 on the base film 360, thereby completing the lens sheet 370. Here, each of the convex lenses has a semi-elliptical shape.

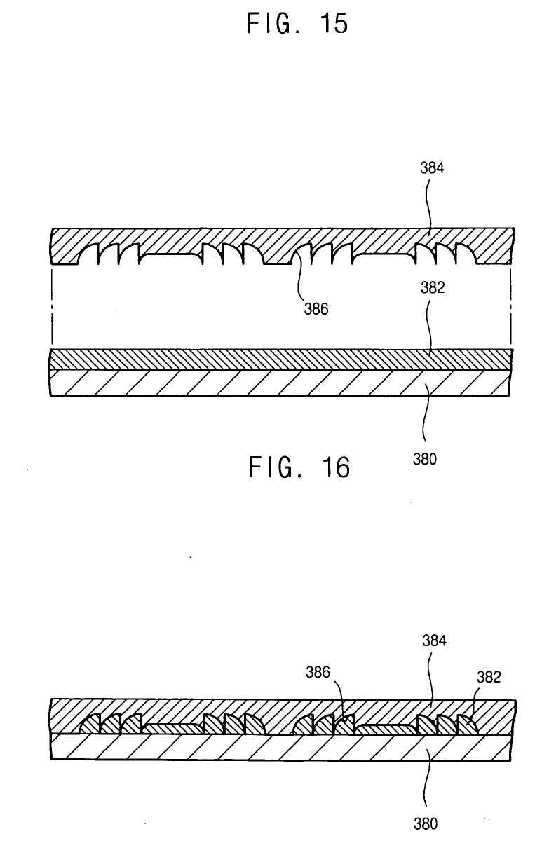

FIGS. 15 to 17 are cross-sectional views illustrating a process for manufacturing a light-concentrating sheet having a light-concentrating pattern.

Referring to FIG. 15, a coating film 382 having a uniform thickness is formed on a base film 380. An example of the base film 380 includes polyethylene terephthalate (PET). The coating film 382 includes an ultraviolet curable resin or a thermosetting resin.

A second master mold 384 having grooves 386 that correspond to the light-concentrating pattern 350 is then positioned over the coating film 382.

Referring to FIG. 16, the second master mold 384 is pressed into the coating film 382 to form the light-concentrating pattern 350 having a plurality of concentric circles. An ultraviolet ray or heat is applied to the light-concentrating pattern 350 to harden the light-concentrating pattern 350.

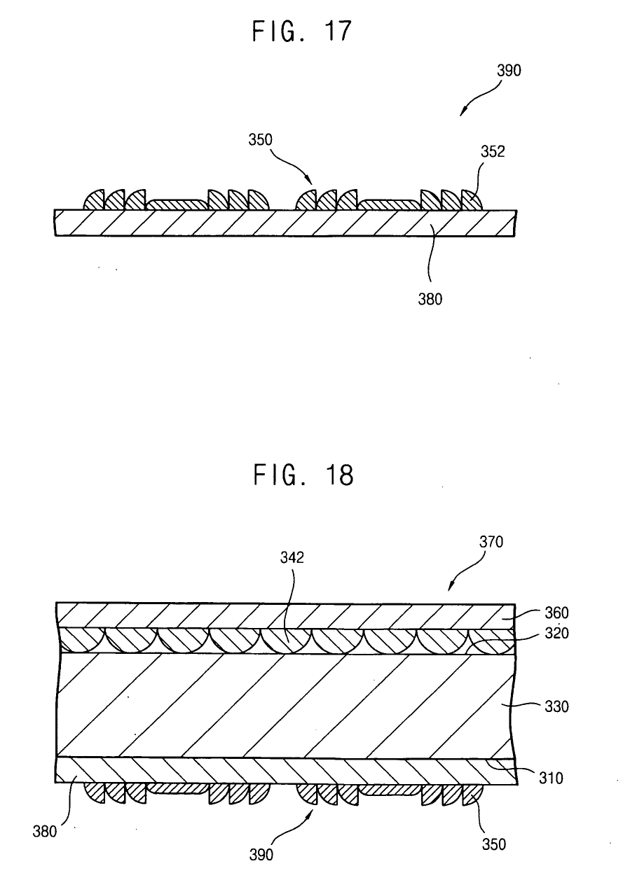

Referring to FIG. 17, after hardening the light-concentrating pattern 350, the second master mold 384 is removed, leaving the concentric circles 352 on the base film 360. This way, the light-concentrating sheet 390 is prepared. In the particular embodient, the light-concentrating pattern has a Fresnel lens pattern.

Referring to FIG. 18, the lens sheet 370 is attached to the light-exiting face 320 of the diffusion plate 330. Here, the convex lenses 342 of the lens sheet 370 make contact with the light-exiting face 320. In addition, the lens sheet 370 may be attached to the diffusion plate 330 using an ultraviolet curable resin.

The light-concentrating sheet 390 is attached to the light-incident face 310 of the diffusion plate 330. Here, the light-concentrating pattern 350 of the light-concentrating sheet 390 is located on the surface that is exposed. Further, the light-concentrating sheet 390 may be attached to the diffusion plate 330 using an ultraviolet curable resin.

As described above, the optical member 300 is manufactured by attaching the light-concentrating sheet 390 and the lens sheet 370 to the light-incident face 310 and the light-exiting face 320 of the diffusion plate 330, respectively.

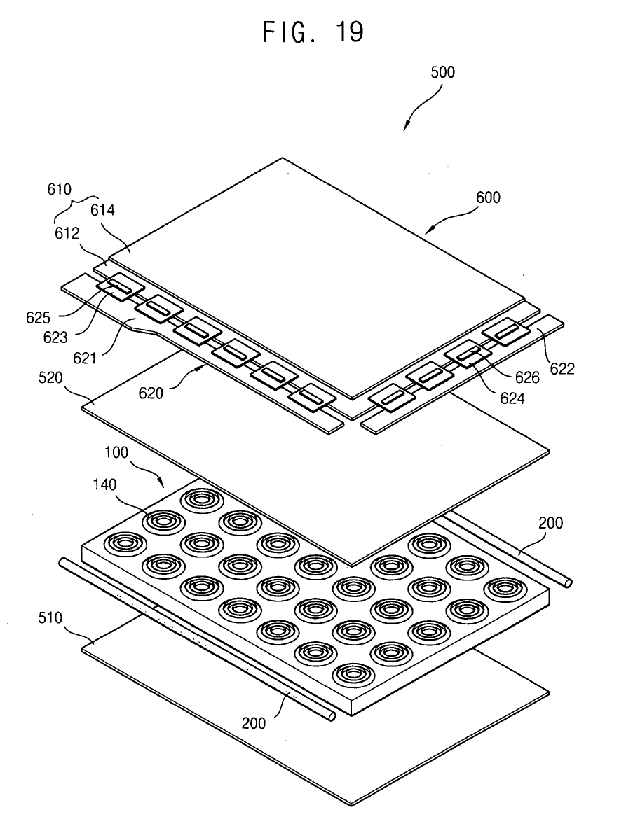

FIG. 19 is an exploded perspective view illustrating a display device in accordance with yet another embodiment of the present invention.

Referring to FIG. 19, a display device 500 of this embodiment includes lamps 200, an optical member 100 and a display unit 600.

The lamps 200 are positioned along two parallel edges of the optical member 100. As described above, only one lamp 200 may be arranged at one side of the optical member 100, depending on the embodiment. Sometimes, multiple lamps 200 may be arranged near one edge of the optical member 100.

When an inverter (not shown) applies power to the lamps 200, the lamps 200 emit light. In this embodiment, the lamps 200 include a cold cathode fluorescent lamp (CCFL) having a thin long cylindrical shape. Alternatively, the lamps 200 may include an external electrode fluorescent lamp (EEFL) having an outer electrode.

The display device 500 may further include a lamp cover (not shown) covering three sides of each of the lamps 200 for protection. The lamp cover may be made with a material having a high reflectivity. Alternatively, the lamp cover may be a non-reflective or less reflective structure that is coated with a material having a high reflectivity. The lamp cover reflects the lights emitted from the lamps 200 to improve light efficiency.

The optical member 100 concentrates the light it receives from the lamps 200 and transmits the concentrated light in an upward direction. The optical member 100 has a structure that is shown in FIGS. 1 to 4. Thus, any further illustrations with respect to the optical member 100 are omitted herein for brevity.

A reflective sheet 510 is positioned under the optical member 100. The reflective sheet 510 reflects light that leak through a bottom face of the optical member 100 back toward the optical member 100. The reflective sheet 510 includes a high-reflectivity material such as white polyethylene terephthalate (PET), white polycarbonate (PC), etc.

A diffusion sheet 520 is arranged over the optical member 100. The diffusion sheet 520 diffuses the concentrated light transmitted from the optical member 100 to improve the overall luminance uniformity.

As illustrated above, the optical member 100 having the Fresnel-lens light-concentrating pattern is used in the display device 500. The optical member 100 allows any additional prism sheet for concentrating the light to be omitted.

The display unit 600 includes a display panel 610 for displaying an image using the concentrated light through the optical member 100. There is also a driving circuit 620 for driving the display panel 610. The display panel 610 includes a first substrate 612, a second substrate 614 positioned in a plane parallel to the plane of the first substrate 612, and a liquid crystal (LC) layer (not shown) interposed between the first and second substrates 612 and 614.

The first substrate 612 corresponds to a transparent glass substrate on which TFTs are arranged in a matrix configuration. In an exemplary embodiment, the first substrate 612 includes a transparent glass for allowing the light to pass through the first substrate 612. The TFTs include a source terminal electrically connected to a data line, a gate terminal electrically connected to a gate line, and a drain terminal electrically connected to a pixel electrode. The pixel electrode includes a transparent conductive material.

The second substrate 614 corresponds to a color filter substrate on which RGB pixels for forming colors are formed by a thin film forming process. A common electrode is formed on the second substrate 614.

When a power is applied to the gate terminal of the TFT, the TFT is turned on so that an electric field is generated between the pixel electrode and the common electrode. The electric field alters the arrangement of the LC molecules in the LC layer, which is interposed between the first and second substrates 612 and 614. Transmission of light through the LC layer changes in accordance with the change in the arrangement of the LC molecules. Hence, an image having a desired gradation can be displayed by controlling the electric field in the LC layer.

The driving circuit 620 includes a data printed circuit board (PCB) 621 for supplying a data driving signal to the display panel 610, a gate PCB 622 for supplying a gate driving signal to the display panel 610, a data driving circuit film 623 connected between the data PCB 621 and the display panel 610, and a gate driving is circuit film 624 connected between the gate PCB 623 and the display panel 610.

The data driving circuit film 623 and the gate driving circuit film 624 include a data driving chip 625 and a gate driving chip 626, respectively. The data driving chip 625 and the gate driving chip 626 may include a tape carrier package (TCP), a chip-on-film (COF), etc.

Alternatively, when additional signal lines are formed on the display panel 610 and the gate driving circuit film 624, the gate PCB 622 may be omitted.

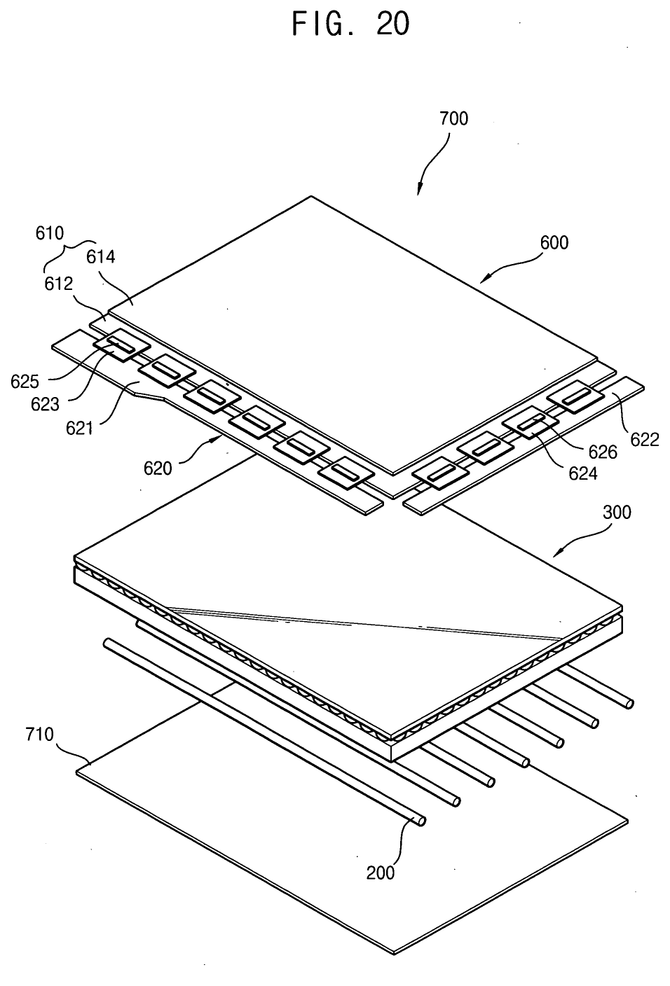

FIG. 20 is an exploded perspective view illustrating a display device in accordance with yet another embodiment of the present invention.

Referring to FIG. 20, a display device 700 of this embodiment includes lamps 200, an optical member 300 and a display unit 600.

The lamps 200 are positioned under the optical member 300. Further, the lamps 200 are arranged substantially parallel to the optical member 300 and parallel to each other. A reflection plate 710 for reflecting the light from the lamps 200 is placed under the lamps 200.

The optical member 300 is positioned over the lamps 200. The optical member 300 diffuses and concentrates the light from the lamps 200 and transmits the concentrated lights in an upward direction. The optical member 300 includes elements substantially the same as those in FIGS. 5 to 7. Thus, any further illustrations with respect to the optical member 300 are omitted herein for brevity.

Further, the display unit 600 is substantially the same as that in FIG. 19. Therefore, any redundant description with respect to the display unit 600 is omitted.

According to this exemplary embodiment, the lens pattern and the light-concentrating pattern are formed on an upper face and a lower face of the optical member, respectively. As the lens pattern and the concentrating pattern are integrated with the optical member, additional optical sheet such as a prism sheet, a reflective polarizing film, etc., is unnecessary.

According to the present invention, the light-concentrating pattern of the Fresnel lens is formed on the light-exiting face of the light-guiding plate. Thus, an additional optical sheet such as a prism sheet for concentrating the light may be omitted, reducing the cost for manufacturing the optical member and the display device. Further, thickness of the optical member and the display device may be reduced by this integration.

Furthermore, the lens array and the light-concentrating pattern are formed on the light-exiting face and the light-incident face of the diffusion plate. Thus, additional optical sheet such as a prism sheet, a diffusion sheet, etc., becomes unnecessary and the cost for manufacturing the optical member and the display device is reduced. The formation of the lens array and the light-concentrating pattern on the diffusion plate also contributes to the reduction in the thickness of the optical member and the display device.

Having described the example embodiments of the present invention and its advantages, it is noted that various changes, substitutions and alterations can be made herein without departing from the spirit and scope of the invention as defined by appended claims.

What is claimed is:

1. An optical member comprising:
a light-incident face receiving light that is emitted by a lamp positioned by a side of the optical member;
a light-exiting face extending in a plane that is perpendicular to the plane of the light-incident face, the light-exiting face having a light-concentrating pattern that includes a plurality of concentric circles; and
a light reflecting face that is opposite to the light-exiting face.

2. The optical member of claim 1, wherein the light-concentrating pattern is a Fresnel lens pattern.

3. The optical member of claim 1, wherein the light reflecting face has a diffusing pattern diffusing and reflecting the light.

4. An optical member comprising:
a diffusion plate including a light-incident face receiving light that is emitted from a lamp and a light-exiting face that is opposite to the light-incident face; and
a lens sheet attached to the diffusion plate, the lens sheet having a lens array that includes a plurality of convex lenses making contact with the diffusion plate.

5. The optical member of claim 4, wherein each of the convex lenses has a semi-elliptical shape.

6. The optical member of claim 4, wherein the light-incident face has a light-concentrating pattern including a plurality of concentric circles that function as a prism.

7. The optical member of claim 6, wherein the light-concentrating pattern has a Fresnel lens pattern.

8. The optical member of claim 4, further comprising a light-concentrating sheet attached to the light-incident face, the light-concentrating sheet having a light-concentrating pattern that includes a plurality of concentric circles.

9. A method of manufacturing an optical member, comprising:
forming a coating film on a light-exiting face of a transparent resin plate;
patterning the coating film using a mold that has grooves of a pattern that is the reverse of a light-concentrating pattern, to form the light-concentrating pattern having a plurality of concentric circles that function as a prism on the coating film; and
hardening the light-concentrating pattern.

10. The method of claim 9, wherein the coating film comprises an ultraviolet curable resin.

11. The method of claim 9, wherein the light-concentrating pattern has a Fresnel lens pattern.

12. The method of claim 9, further comprising forming a diffusing pattern on a light reflecting face of the transparent resin plate that is opposite to the light-exiting face.

13. A method of manufacturing an optical member, comprising:
forming a lens sheet on a light-exiting face of a diffusion plate, the lens sheet having an array of convex lenses making contact with the light-exiting face; and
forming a light-concentrating pattern on a light-incident face of the diffusion plate that is opposite to the light-exiting face, the light-concentrating pattern having a plurality of concentric circles.

14. The method of claim 13, wherein forming the lens sheet comprises:
forming a coating film on a base film;
patterning the coating film using a first master mold that has grooves of a pattern that is reverse of the array of convex lenses;
hardening the array of convex lenses; and
attaching the array of convex lenses to the light-exiting face for allowing the convex lenses to make contact with the light-exiting face.

15. The method of claim 14, wherein the coating film comprises an ultraviolet curable resin.

16. The method of claim 14, wherein each convex lens in the array has a semi-elliptical shape.

17. The method of claim 13, wherein forming the light-concentrating pattern comprises:
forming a coating film on a base film;
patterning the coating film using a second master mold that has grooves of a pattern that is reverse of the light-concentrating pattern, to form a light-concentrating sheet having the light-concentrating pattern;
hardening the light-concentrating sheet; and
attaching the light-concentrating sheet to the light-incident face.

18. The method of claim 17, wherein the coating film comprises an ultraviolet curable resin.

19. The method of claim 17, wherein the light-concentrating pattern has a Fresnel lens pattern.

20. A display device comprising:
a lamp emitting light;
an optical member including a light-incident face and a light reflecting face that are opposite each other and a light-exiting face in a plane that is perpendicular to the light-incident face and the light-reflecting face, the light-incident face receiving the light from the lamp and having a light-concentrating pattern including a plurality of concentric circles; and
a display panel arranged on the light-exiting face of the optical member to display an image.

21. The display device of claim 20, wherein the light-concentrating pattern has a Fresnel lens pattern.

22. The display device of claim 20, further comprising:
a reflection plate positioned under the optical member; and
a diffusion sheet placed on the optical member.

23. A display device comprising:
lamps arranged parallel to each other and emitting light;
an optical member positioned to receive the light from the lamps, the optical member including a diffusion plate that includes a light-incident face and a light-exiting face that are opposite each other and a lens sheet attached to the diffusion plate, wherein the lens sheet has a lens array that includes a plurality of convex lenses making contact with the diffusion plate; and
a display panel positioned on the optical member to display an image.

24. The display device of claim 23, wherein each of the convex lenses has a semi-elliptical shape.

25. The display device of claim 23, wherein the light-incident face has a light-concentrating pattern including a plurality of concentric circles.

26. The display device of claim 25, wherein the light-concentrating pattern has a Fresnel lens pattern.

27. The display device of claim 23, further comprising a diffusion plate placed under the lamps.
